(19) United States
(12) Patent Application Publication
(10) Pub. No.: US 2020/0338822 A1
(43) Pub. Date: Oct. 29, 2020

(54) MULTI-HOTEND NOZZLE EXTRUDER ASSEMBLY DEVICE

(71) Applicant: The Board of Regents for the Oklahoma Agricultural and Mechanical Colleges, Stillwater, OK (US)

(72) Inventors: Benjamin Luke Davenport, Greencove Springs, FL (US); Gannon Crockett Griffith, Stillwater, OK (US); Daniel Lee Bruton, Kellyville, OK (US)

(73) Assignee: The Board of Regents for the Oklahoma Agricultural and Mechanical Colleges, Stillwater, OK (US)

(21) Appl. No.: 16/857,508

(22) Filed: Apr. 24, 2020

Related U.S. Application Data
(60) Provisional application No. 62/838,609, filed on Apr. 25, 2019.

(51) Int. Cl. B29C 64/209; B29C 64/295; B29C 64/241; B29C 64/118; B29C 64/25

(52) U.S. Cl. CPC B29C 64/209; B29C 64/295; B33Y 30/00; B29C 64/118; B29C 64/25; B29C 64/241

(57) ABSTRACT

An embodiment is a form of an additive manufacturing (FDM) hotend that is composed of multiple tool heads or nozzles, preferably each with a different aperture diameter. This embodiment provides the printer the ability to print at different nozzle sizes with quick actuations of tool changes and preform print speeds faster than a stock extruder. This embodiment of a hotend is small as compared to default extruders and will allow the user to print at fast print speeds without sacrificing tolerance-based prints based on using a combination of small and large nozzle sizes. This version of the assembly is round with an accommodating control box to which allows the desired nozzle to be rotated into position, preferably under software control.

### CROSS REFERENCE TO RELATED APPLICATIONS

This application claims the benefit of U.S. Provisional Patent Application Ser. No. 62/838,609 filed on Apr. 25, 2019, and incorporates said provisional application by reference into this document as if fully set out at this point.

### TECHNICAL FIELD

This disclosure relates generally to print heads for 3D printers and, more particularly, to a print head apparatus for facilitating 3D printing where nozzles with different aperture sizes are to be utilized in printing an item.

### BACKGROUND

3D printing is increasingly popular and affordable. As is known to those of ordinary skill in the art, 3D printing is a form of additive manufacturing which typically involves building up a 3D object by laying down successive horizontal layers of an extrudable material (e.g., plastic, liquid metal, resin, acrylic gel, etc., including mixtures of same) which is extruded through the nozzle in a print head. The printer is guided by a digital 3D model from, e.g., a CAD system which represents the object that is to be created.

The last component in the 3D printing assembly is the print head nozzle. An aperture in the terminus of the nozzle controls the thickness of the material that is laid down. As might be suspected, in some instances a larger nozzle aperture might be desired, e.g., if the particular item did not have a great deal of detail. On the other hand, if there is a fine detail in the 3D model that is to be printed, a smaller nozzle aperture could be preferred. To the extent that a larger nozzle aperture can be used, it will speed up the printing process by laying down thicker layers, thereby requiring fewer passes over the object that is being built.

Of course, changing between different nozzles, which might be desired either during the printing of a single object or between the printing of two different objects, is time consuming. Further, present approaches do not allow the user to fine tune the nozzle aperture size to match the amount of detail in a particular object without time consuming disassembly of the print head.

As such, what is needed is a mechanism that allows rapid changes of the print nozzle to accommodate the characteristics of different 3D printed objects.

Before proceeding to a description of the present invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY

An embodiment is a form of an additive manufacturing (FDM) 3D print head that is composed of multiple tool heads or nozzles which are mounted in a rotatable fashion so that each nozzle can be brought in turn into fluid communication with a source of molten material. This embodiment provides the printer with the ability to print using different nozzle sizes with quick actuations of tool changes which results in print speeds that are faster than would be obtained from a stock extruder. One embodiment of a print head will preferably be made to be relatively small (as compared with many extruders) which will allow the user to print using a combination of small and large nozzle sizes at fast print speeds without sacrificing tolerance. One version of the inventive print head contains nozzles that are mounted along a semicircular arc that are rotatable under software control to select a nozzle of the appropriate aperture diameter so that it can be placed place into fluid communication with the molten material that is supplied by the print head hotend.

One embodiment includes a 3D printer head, comprising a hotend assembly, a hotend component within said hotend assembly, said hotend component at least for heating an extrudable material to a melting point; and, a rotatable plate supported by said hotend assembly and comprising a plurality nozzles, where each of said nozzles is rotatable to be separately in fluid communication with said hotend component, and preferably each of said plurality of nozzles having an aperture of a different diameter from the others.

Another embodiment provides a 3D printer apparatus, comprising a printer frame; a gantry mounting system supported by said printer frame; a hotend assembly supported by said gantry system and positionable to be in fluid communication with an extrudable material, a hotend component supported by said hotend assembly; a rotatable plate supported by said hotend assembly and comprising a plurality of nozzles, each of said nozzles containing an aperture of a different diameter from the other nozzles, wherein said plate is rotatable to bring each of said nozzles in turn to be in fluid communication with said hotend component; a print head drive system in mechanical communication with said hotend assembly; a microprocessor operatively coupled to said print head drive system, said microprocessor at least for controlling a position of said hotend assembly using said print head drive system and instructing said rotatable plate to rotate to place a specific one of said plurality of nozzles in fluid communication with said hotend component; and a power supply in electrical communication with said microprocessor and said print head drive system.

A 3D printer head comprising: an hotend assembly, said hotend assembly comprising a hotend component; a plurality of nozzles rotatably mounted on said attachment assembly, each of said nozzles having a terminus containing an aperture, each of said apertures being of a different diameter, said rotatable hotend assembly being positionable to be affixed to a 3D printer, each of said nozzles being rotatable to be in fluid communication with a feed line from an extrudable material source; and a motor in mechanical communication with said rotatable attachment assembly, said motor at least for rotating said plurality of nozzles to place each of said nozzles in fluid communication with the feed line from the extrudable material source.

The foregoing has outlined in broad terms some of the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1A is a perspective view of an embodiment of the instant print head; FIG. 2A contains an exploded view of the embodiment of FIG. 1A.

FIG. 2 shows a cut away view of an assembled view of the embodiment of FIG. 1.

FIG. 3 contains a schematic view of an embodiment.

FIGS. 4A, 4B, and 4C illustrate how the print head nozzles can be rotated into position to be in fluid communication with the extrudable material.

FIG. 5 contains an exemplary motor control box suitable for use with an embodiment.

FIG. 6 contains an example of how the instant invention might be utilized in practice.

### DETAILED DESCRIPTION

While this invention is susceptible of embodiment in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments or algorithms so described.

According to an embodiment, the multi-nozzle print head assembly taught herein gives a 3D printer the ability to produce high tolerance parts while printing with any combination of high and low diameter nozzle apertures. This allows the printer to print complex shapes without wasting the time that would otherwise be spent in-filling in major sections of the printed object using a small aperture nozzle in order to avoid having to change to a larger size.

Note that, for purposes of the instant disclosure, when a reference is made to the diameter or size of a nozzle or hotend, the intent is that term describes the size of the aperture at the terminus of the nozzle or hotend through which the molten plastic or other material flows during the 3D printing operation.

According to an embodiment, nozzles with a plurality of different aperture diameters are interchanged by rotatably mounting them so that they can be rotated into position when needed. In some embodiments the nozzles might be oriented at 30 degree angles with respect to each other. When a change to the nozzle diameter or access to a different nozzle is needed based on the parameters of the object to be printed, a different nozzle can quickly and easily be rotated into position.

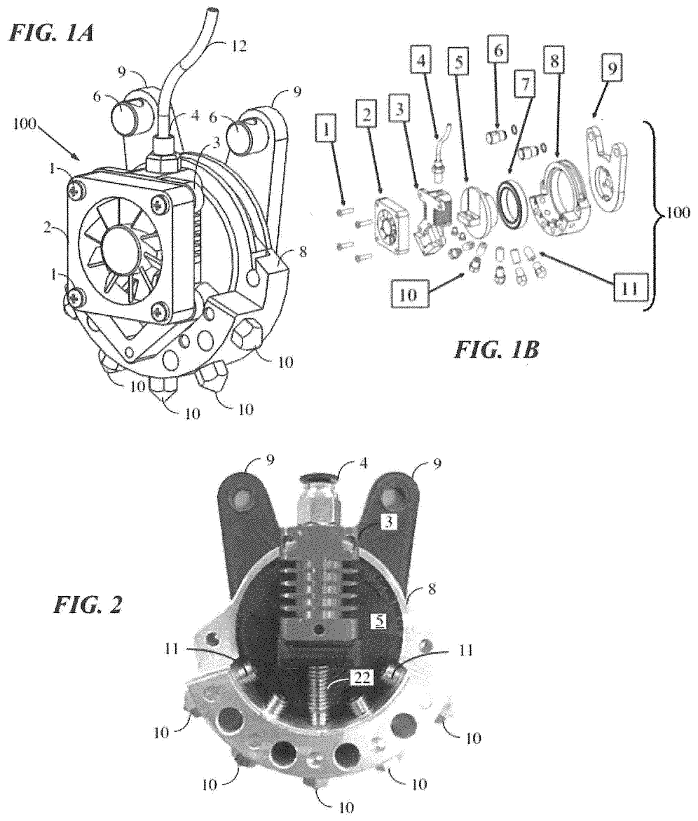

FIGS. 1A and 1B contain illustrations of an embodiment 100. FIG. 1A provides an assembled view and FIG. 1B provides an exploded view of this particular embodiment. As can be seen, bolts 1 are provided to affix a fan 2 to a hotend heat break assembly 3 that, in some embodiments, includes a detent for use with a spring and ball mechanism that aligns the nozzles with the flow of molten printing material. In some embodiments the fan 2 might range in size from 30 mm to 50 mm, but other fan sizes are certainly possible and a person of ordinary skill in the art will readily be able to select a size that is appropriate for a particular application.

Additionally provided in this particular embodiment are a filament top guide 4 and a front plate 5. The top guide 4 is at least for guiding a feed line 12 which conveys a meltable filament from its source to the hotend component 3. Plate 5 is a bracket that connects to the back plate 9 and secures the hotend component 3 in a fixed vertical position. Cable guides 6 are attachable to back plate 9 to provide an attachment to facilitate X/Y positioning of the print head 100 under computer control. The instant embodiment is preferably made rotatable through the use of a bearing 7 which supports the rotating plate 8, with the bearing 7 being mounted on back plate 9. For purposes of the instant application, the mechanical components that are associated with supporting the hotend component 3 will collectively be referred to as the hotend assembly hereinafter).

Nozzles 10 deposit the molten material and contain a conduit therethrough that is in fluid communication with a throat heat break 11 which contains an internal conduit that is, in turn, in fluid communication with the hotend heat break 22 (FIG. 2) which heats the material passing therethrough to a melting point. The resulting molten material is then used in the 3D printing process.

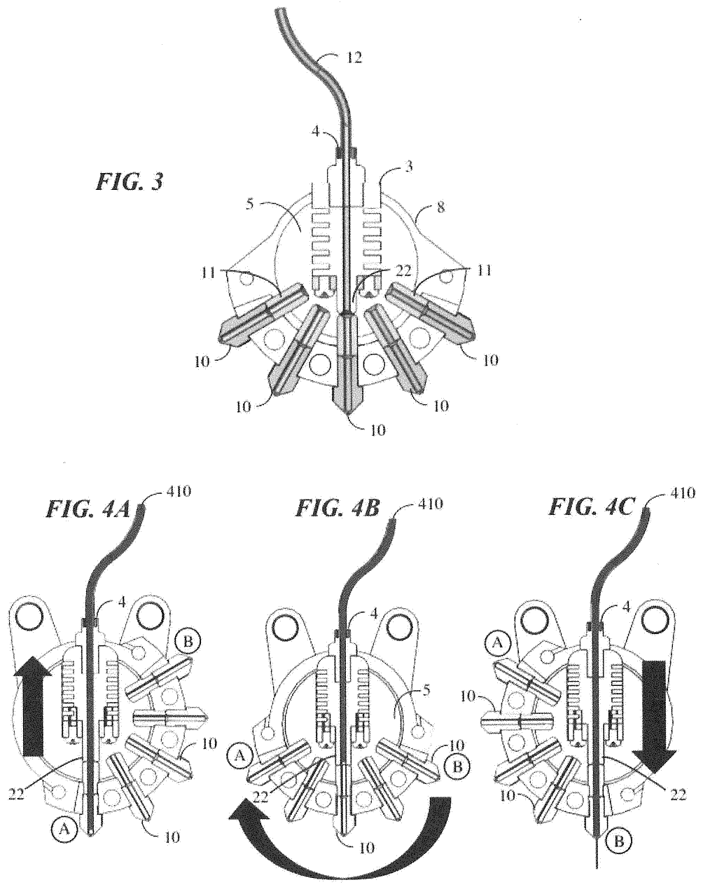

FIGS. 2 and 3 contain a cross sectional views of an embodiment. With respect to FIG. 3, hotend heat break 22 is connected to extruders assemblies and nozzles with are the heart of a 3D printer. They supply filament to the required source based on, for example, the gcode passed though the main board on the printer. The material that exits from the hotend component 3 will typically generate a temperature of between 170° and 350° Celsius, depending on the source material. A fan 2 is provided to keep the top of the hotend component 3 cool. That allows the material that is to be extruded to maintain a solid form until it approaches the bottom of the hotend component 3. This is the point where the source materials are transformed to a molten state before being extruded.

FIG. 4 illustrates how an embodiment might operate in practice. This variation utilizes one hotend break assembly 22 and five matching rotatably mounted nozzles 10, although those of ordinary skill in the art will be easily able to fashion alternative versions with different numbers of hotends and/or nozzles, with the hotend(s) being rotatable along with the nozzles or not. According to one variation, the nozzles 10 are rotatably mounted via a bearing 7 that is, in turn, mounted to the back plate 9 to be separately in fluid communication with the extrudable material. The embodiment of FIG. 4 illustrates one preferred series of operations that could be used to replace the currently active nozzle “A” with nozzle “B”.

As is indicated in FIG. 4A, nozzle “A” is currently dispensing material 410 which has been heated to the melting point so that it can be extruded via the nozzle 10 onto a workpiece, e.g., item 610 in FIG. 6. It will be assumed for purposes of this illustration alone, that the substance that comprises the extrudable material that can be melted and extruded. As a specific example, plastic filament could be used. Materials that would be suitable for use herein will be referred to generically as extrudable materials.

As an preparatory step to rotation, the plastic filament 410 will be retracted, preferably using the Bowden tube system, into the cooler portion of the hotend component 3. After that has been done, the mechanism will be clear to be rotated. The plate 8 will next be rotated 120 degrees (in this example), with the rotation being powered by, for example, a pull cord or a motor on top of the assembly (not shown). In some embodiments the motor will utilize a simple spur gear. In some embodiments, the gear would be a stepper due to its accuracy. Those of ordinary skill in the art will recognize that a Bowden extruder is a type of filament feeding mechanism used in many FDM 3D printers that pushes filament though a long and flexible PTFE (Teflon) tube to the hotend.

In some embodiments, the hotend component 3 will be positioned so that its heat break 22 is in fluid communication with the throat heat break 11 using a spring ball and detent system that might be mounted on the front of the plate 5. Once the plate 8 has rotated to the desired nozzle B (FIG. 4C) position and locked it into position, pushing of the plastic through the hotend component to the molten zone will resume and printing using the molten source material can continue.

The invention taught herein allows the device 100 to be operated to quickly change between nozzle sizes, preferably under computer control. The instant approach is suitable for use with most 3D printers since it can be constructed to have a relatively small size, e.g., preferably only 75 mm in width in some embodiments. Similarly, the weight in some embodiments can be reduced to a minimum which tends to decrease the inertia problem which arises in some printers, e.g., the weight of the extruder assembly can cause failed prints. A variety of metals can be used in design but, preferably, the instant invention 100 will be constructed of light weight metals and plastics. Steel components might be used for fasteners and general hardware. The nozzles 10 could be formed of brass, steel, or any other suitable material based on the needs of the particular embodiment. Some embodiments will have nozzles that are configured to withstand heating to temperatures of 350° Celsius for long periods of time.

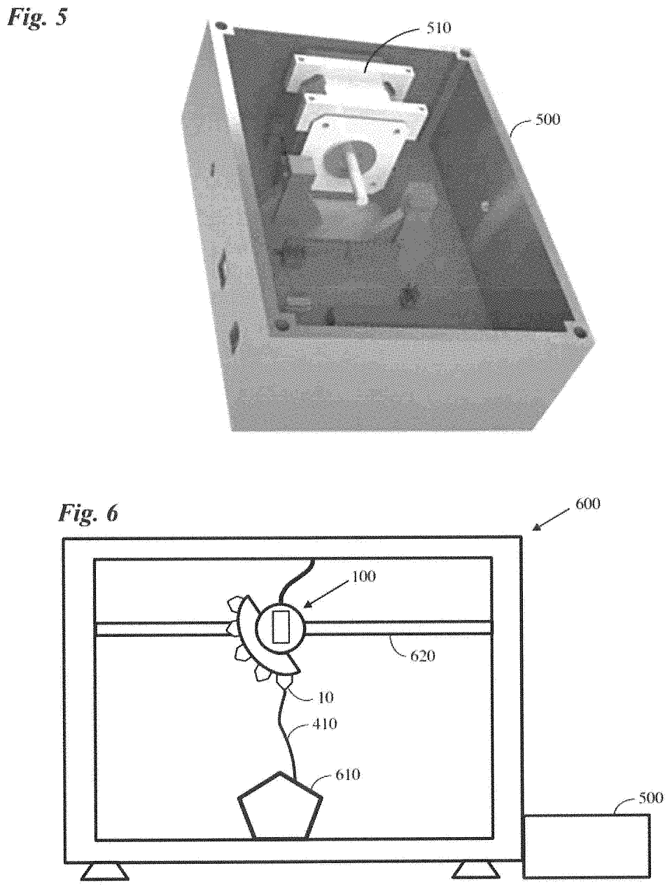

FIG. 5 contains an exemplary motor control housing 500 suitable for use with an embodiment. The housing 500 in some embodiments will contain a drive assembly which comprises a stepper motor 510. The stepper motor 510 is adapted to control the position of the rotating plate 8. Additionally, and preferably, interior to the housing 500, some embodiments will utilize a microprocessor (e.g., a board-based computer, or a CPU) which is configured to control the position of the drive assembly 510 and, more generally, drive the printer head assembly that includes the instant rotatable embodiment 100. Note that the term “microprocessor” as it is used herein should be given its broadest possible meaning and should at least be construed to include any programmable logic device suitable for controlling, directly or indirectly, a 3D print head. In this example, an external or internal power source will supply the drive assembly with the necessary power to operate. Additionally, this same power source might also be utilized by the computer CPU that controls the system.

Additionally, the embodiment of FIG. 5 might include a motor to drive the mechanism which might, in the alternative, be on the head assembly itself if weight is not a problem. A power supply for the entire assembly (heater cartage) is supplied by the printer in some embodiments or the printer could be made to accommodate said box within or alone in total system.

Turning next to FIG. 6, this figure contains an example of how an embodiment might be used in practice. In operation, the instant print head 100 will typically be supported by a gantry system 620 within a conventional 3D printer frame 630 and be placed in electronic and mechanical communication with controlling motors and a CPU, preferably of the sort within enclosure 500. In some embodiments, the print head 100 will be positioned using some number of belts and and/or threaded rods that control its X, Y, and Z position within the frame. In some embodiments, the belts will be in mechanical communication with a corresponding number of stepper motors which are under computer control to position the print head according to the instructions executed by the computer. The mechanical components that position the print head 100 will collectively be referred to as the drive system, hereinafter. The workpiece 610 will rest on the print bed which may be self-leveling, or not. As should be clear, in this embodiment the workpiece 610 is built up by successive passes of the printhead 100 according to methods well known to those of ordinary skill in the art. Not shown in FIG. 6 is a power supply that is utilized by the CPU and print head drive system. Those of ordinary skill in the art will recognize that the foregoing contains examples of a typical 3D printing system and those of ordinary skill in the art will be readily able to devise alternatives.

In practice, the instant invention has proven to be a time saver when printing 3D objects. In one example, printing with a 0.4 mm nozzle required a printing time of 2:56:39 which had very good tolerance/resolution but with an excessive print time. Printing with a larger nozzle of 1.2 mm results in a reduced print time of 1:18:26, but with poor tolerance/resolution on the outside wall layers of the model build. Using a combination of the two sizes resulted in a print time of 1:03:56 without sacrificing tolerance requirements. Begin able to quickly switch between nozzle sizes makes it possible to have continuity in the build and increase its speed. In some embodiments, the nozzle apertures that are used for detailed printing might vary between 0.2 mm and 0.6 mm, based on the tolerance surfaces located within the model design. Nozzle apertures of 0.8 mm to 1.2 mm can be used to fill surfaces quickly which otherwise could take a great deal of time if the 0.2 mm to 0.6 mm nozzles were used. Obviously, the instant invention can be configured with any useful range of nozzle sizes and those listed herein are just given as illustrative examples.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Still further, additional aspects of the instant invention may be found in one or more appendices attached hereto and/or filed herewith, the disclosures of which are incorporated herein by reference as if fully set out at this point.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A 3D printer head, comprising:
(a) a hotend assembly,
(b) a hotend component within said hotend assembly, said hotend component at least for heating an extrudable material to a melting point; and
(c) a rotatable plate supported by said hotend assembly, said rotatable plate comprising a plurality nozzles,
each of said nozzles being rotatable to be separately in fluid communication with said hotend component, and
each of said plurality of nozzles having an aperture of a different diameter from the others.

2. The 3D printer head according to claim 1, wherein said plurality of nozzles comprises five nozzles.

3. The 3D printer head according to claim 1, wherein said nozzle apertures vary in diameter between 0.2 mm and 1.2 mm.

4. The 3D printer head according to claim 1, wherein said extrudable material is one or more of plastic, liquid metal, resin, or acrylic gel.

5. A 3D printer apparatus, comprising:
(a) a printer frame;
(b) a gantry mounting system supported by said printer frame;
(c) a hotend assembly supported by said gantry system and positionable to be in fluid communication with an extrudable material,
(d) a hotend component supported by said hotend assembly;
(e) a rotatable plate supported by said hotend assembly and comprising a plurality of nozzles, each of said nozzles containing an aperture of a different diameter from the other nozzles, wherein
said plate is rotatable to bring each of said nozzles in turn to be in fluid communication with said hotend component;
(f) a print head drive system in mechanical communication with said hotend assembly;
(g) a microprocessor operatively coupled to said print head drive system, said microprocessor at least for
controlling a position of said hotend assembly using said print head drive system, and
instructing said rotatable plate to rotate to place a specific one of said plurality of nozzles in fluid communication with said hotend component; and
(h) a power supply in electrical communication with said microprocessor and said print head drive system.

6. The 3D printer apparatus according to claim 5, wherein said plurality of nozzles comprises five nozzles.

7. The 3D printer apparatus according to claim 5, wherein said nozzle apertures vary in diameter between 0.2 mm and 1.2 mm.

8. A 3D printer head, comprising:
(a) a hotend assembly, said hotend assembly comprising
a top filament guide mounted on said hotend assembly,
a hotend component mounted on said hotend assembly and in mechanical communication with said top filament guide,
(b) a feed line in mechanical communication with said top filament guide, said feed line at least for guiding an extrudable filament to said top filament guide;
(c) a rotatable plate mounted on said hotend assembly, said rotatable plate having a plurality of nozzles,
each of said nozzles being rotatable to be in fluid communication with said hotend component and said extrudable filament, and
each of said nozzles having a terminus containing an aperture, each of said apertures being of a different diameter, and
(d) at least one motor in mechanical communication with said rotatable plate, said motor at least for rotating said plurality of nozzles to place one of said nozzles in fluid communication with the hotend component and said extrudable filament.

9. The 3D printer head according to claim 8, wherein said extrudable material filament is a molten plastic, a liquid metal, a resin, or an acrylic gel.

10. The 3D printer head according to claim 8, wherein said plurality of nozzles comprises five nozzles.

11. The 3D printer head according to claim 8, wherein said nozzle apertures vary in diameter between 0.2 mm and 1.2 mm.

12. The 3D printer head according to claim 8, wherein said extrudable material is one or more of plastic, liquid metal, resin, or acrylic gel.
